(19) United States
(12) Patent Application Publication
(10) Pub. No.: US 2024/0263506 A1
(43) Pub. Date: Aug. 8, 2024

(54) LID OPENING/CLOSING DEVICE

(71) Applicant: TOYODA GOSEI CO., LTD., Kiyosu-shi (JP)

(72) Inventors: Kenichiro KANEKO, Kiyosu-shi (JP); Kazuki FUJISAWA, Nagoya-shi (JP)

(21) Appl. No.: 18/392,019

(22) Filed: Dec. 21, 2023

(30) Foreign Application Priority Data
Feb. 8, 2023 (JP) 2023-017994

(51) Int. Cl. E05F 15/63

(52) U.S. Cl. CPC E05F 15/63; E05Y 2201/10; E05Y 2600/32; E05Y 2600/56; E05Y 2900/534

(57) ABSTRACT

An object is to suppress rattling of a lid due to a clearance in a link mechanism. A lid opening/closing device includes an actuator box in which an actuator is housed, and a link mechanism interposed between the actuator and a lid. The link mechanism includes a shaft member extending between the actuator box and a lid box. The lid box has a fitting hole into which another axial end portion of the shaft member mounted to the actuator box at one axial end portion thereof before assembly between both boxes is inserted. Both boxes have a guide portion for guiding both boxes during the assembly by inserting the shaft member into the fitting hole. The guide portion has a rotation guide portion for rotating the actuator box about an axis of the shaft member toward a lid closing side with respect to the lid box during the assembly.

### TECHNICAL FIELD

The present invention relates to a lid opening/closing device capable of opening/closing a lid for opening/closing an opening of a lid box that is mounted on a vehicle body, for example.

### BACKGROUND ART

Hitherto, a lid opening/closing device using an actuator to open/close a lid for opening/closing an opening of a lid box has been known (e.g., Japanese Laid-Open Patent Publication No. 2022-110989). The lid opening/closing device described in Japanese Laid-Open Patent Publication No. 2022-110989 includes a link mechanism interposed between an actuator and a lid. The link mechanism is a mechanism that transmits power generated by the actuator to the lid.

The actuator is housed in an actuator box. The actuator box is placed outside a lid box. A member coupled to a rotation shaft of the actuator and forming a part of the link mechanism, etc., are also housed in the actuator box. A lid shaft forming a part of the link mechanism and configured to rotate by the power of the actuator extends in a shaft shape between the actuator box side and the lid box side.

### SUMMARY OF INVENTION

### Technical Problem

In the link mechanism between the actuator and the lid described above, there is a clearance due to a tolerance and the like. If the lid opening/closing device is assembled without considering this clearance, for example, the closed position of the lid may deviate from the desired position, causing the lid to rattle.

The present invention has been made in view of such circumstances, and an object of the present invention is to provide a lid opening/closing device capable of suppressing rattling of a lid due to a clearance in a link mechanism.

### Solution to Problem

An aspect of the present invention is directed to a lid opening/closing device including: a lid box having an internal space and an opening through which the internal space is exposed to outside; a lid configured to be opened/closed between a closed position at which the opening is closed and an opened position at which the opening is opened; an actuator configured to generate power for opening/closing the lid; an actuator box in which the actuator is housed and which is placed outside the internal space of the lid box; and a link mechanism interposed between the actuator and the lid and configured to transmit the power generated by the actuator to the lid, wherein the link mechanism includes a shaft member extending in a shaft shape between the actuator box side and the lid box side and configured to rotate by the power, the shaft member is mounted to one side out of the actuator box and the lid box at one axial end portion thereof before assembly between the actuator box and the lid box is performed, the other side out of the actuator box and the lid box has a fitting hole into which another axial end portion of the shaft member is inserted, the actuator box and the lid box have a guide portion configured to guide the actuator box and the lid box when the assembly is performed by inserting the other axial end portion of the shaft member into the fitting hole, and the guide portion has a rotation guide portion provided to at least one of the actuator box and the lid box and configured to rotate the actuator box about an axis of the shaft member toward a lid closing side with respect to the lid box in a process in which the assembly proceeds.

With this configuration, rattling of the lid due to a clearance in the link mechanism is suppressed.

### BRIEF DESCRIPTION OF DRAWINGS

FIG. 1 is a perspective view of a lid opening/closing device according to an embodiment of the present invention as seen from the front side at a lid closed position;

FIG. 2 is a perspective view (but a partially see-through view) of the lid opening/closing device of the embodiment as seen from the front side at a lid opened position;

FIG. 3 is a front view of the lid opening/closing device of the embodiment at the lid opened position;

FIG. 4 is a back view of the lid opening/closing device of the embodiment at the lid opened position;

FIG. 5 is a side view of the lid opening/closing device of the embodiment at the lid opened position;

FIG. 6 is a diagram for describing the operation of a link mechanism included in the lid opening/closing device of the embodiment (specifically, a view of the link mechanism as seen from the lateral side);

FIG. 7 is an exploded view of a main part of the lid opening/closing device of the embodiment;

FIG. 8 is a back view showing a state before an actuator box is mounted to a lid box in the lid opening/closing device of the embodiment;

FIG. 9 is a side view showing the state before the actuator box is mounted to the lid box in the lid opening/closing device of the embodiment;

FIG. 10 is a diagram (side view) for describing movement when the actuator box is mounted to the lid box in the lid opening/closing device of the embodiment;

FIG. 11 is a view of the lid opening/closing device shown in FIG. 10 as seen in arrows XI-XI;

FIG. 12 is a diagram showing the structure of a rotation guide portion provided to the lid box of the lid opening/closing device of the embodiment;

FIG. 13 is a diagram showing a state immediately before an actuator box is mounted to a lid box in a lid opening/closing device according to a modification of the present invention;

FIG. 14 is a side view of the lid opening/closing device shown in FIG. 13; and

FIG. 15 is a view of the lid opening/closing device shown in FIG. 14 as seen in arrows XV-XV.

### DESCRIPTION OF EMBODIMENTS

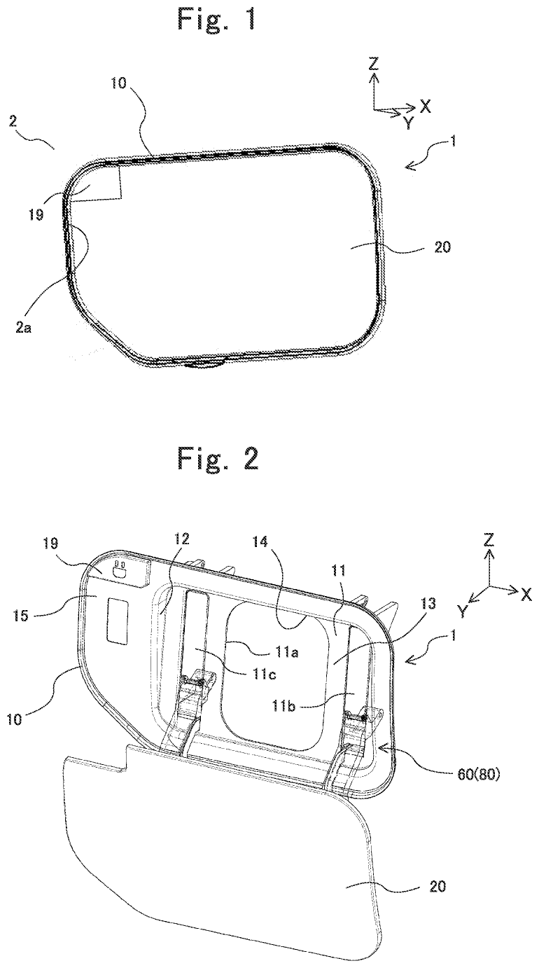

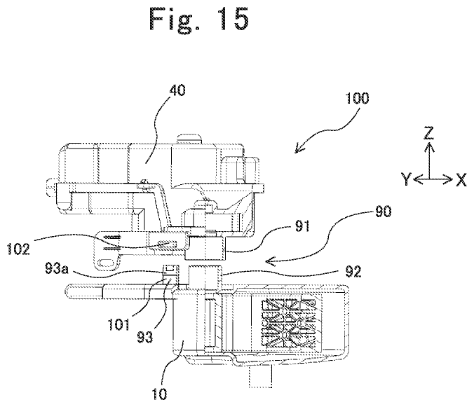

Hereinafter, a specific embodiment of the lid opening/closing device according to the present invention will be described with reference to FIG. 1 to FIG. 15.

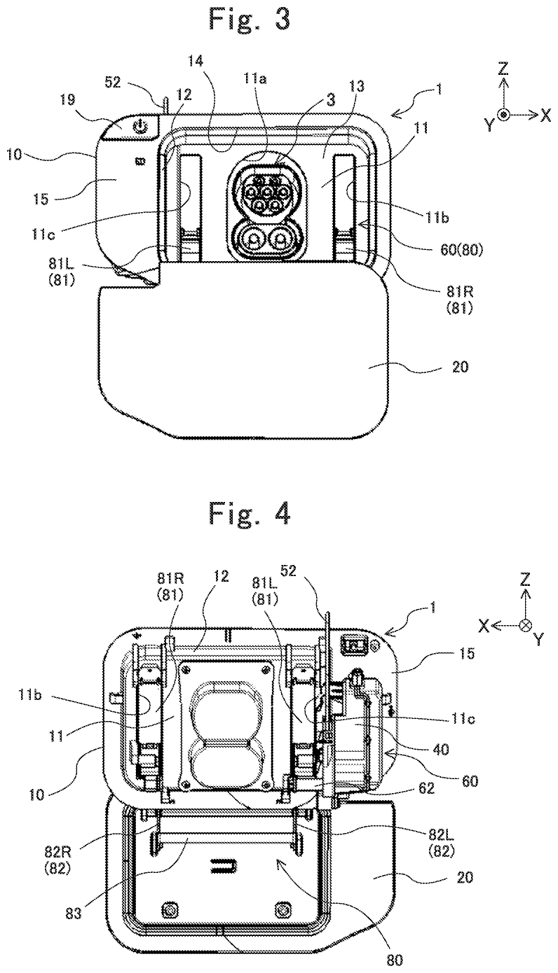

A lid opening/closing device 1 according to the embodiment is a device for opening/closing a lid with respect to a lid box. The lid opening/closing device 1 is mounted, for example, on various vehicles such as a gasoline vehicle, a diesel vehicle, an electric vehicle, and a hybrid vehicle, and is installed in a mounting hole 2a provided in a vehicle body surface 2 of a vehicle body side portion, a vehicle body front portion, or the like, as shown in FIG. 1. For example, a supply port (specifically, a charge port, a fuel port, or the like: see FIG. 3) 3 for supplying energy to the vehicle is placed in the mounting hole 2a.

As shown in FIG. 1 to FIG. 7, the lid opening/closing device 1 includes a lid box 10, a lid 20, an actuator 30, an actuator box 40, an external force operation mechanism 50, and a link mechanism 60. The lid opening/closing device 1 transmits power generated by the actuator 30 to the lid 20 via the link mechanism 60, thereby opening/closing the lid 20 with respect to the lid box 10 between a closed position and an opened position.

The lid opening/closing device 1 only has to be capable of opening/closing the lid 20 at least with the power generated by the actuator 30, but may be capable of opening/closing the lid 20 with power generated by the operation of the external force operation mechanism 50, which is different from the actuator 30, in an emergency such as a failure of the actuator 30. Hereinafter, the lid opening/closing device 1 is also capable of opening/closing the lid 20 by the operation of the external force operation mechanism 50.

Furthermore, in the following, the right-left direction when seen from the front side of the lid 20 is referred to as right-left direction X, a direction in which the near side and the far side of the lid 20 are connected is referred to as front-back direction Y, and the up-down direction is referred to as up-down direction Z. The lid 20 is opened/closed in the up-down direction Z.

The lid box 10 is a container-like or box-like box body in which the supply port 3 is housed. The lid box 10 is mounted and fixed to the vehicle body surface 2 so as to be fitted into the mounting hole 2a. The lid box 10 includes a bottom wall portion 11, a side wall portion 12, an internal space 13, and an opening 14. The lid box 10 is a bottomed tubular member. The lid box 10 includes the bottom wall portion 11 provided on the far side, the side wall portion 12 erected on the near side from the periphery of the bottom wall portion 11, the internal space 13 surrounded by the bottom wall portion 11 and the side wall portion 12, and the opening 14 provided on the near side of the internal space 13. The lid box 10 is an injection-molded article molded from a resin or the like.

The supply port 3 is provided at one end of a pipe or cable connected at another end thereof to a fuel tank, a battery, or the like. The fuel tank or the battery is placed on the far side with respect to a first through hole 11a provided in the bottom wall portion 11. The supply port 3 is housed so as to be exposed in the internal space 13 via the first through hole 11a. While the supply port 3 is hidden on the far side of the lid 20 at the closed position of the lid 20, the supply port 3 is exposed to the outside of the vehicle through the opening 14 at the opened position of the lid 20 so as to allow fuel supply and charging.

The lid box 10 includes a frame portion 15. The frame portion 15 is formed in an annular shape along a peripheral portion of the opening 14, and is formed in a flange shape so as to extend in a frame outward direction from the peripheral portion of the opening 14. The lid box 10 is positioned on the vehicle body surface 2 by bringing the back surface of the frame portion 15 into contact with a flange surface or the like at the periphery of the mounting hole 2a of the vehicle body surface 2.

The lid 20 is a lid member for opening/closing the opening 14 of the lid box 10. The lid 20 is formed in a plate shape. The lid 20 is sized so as to match the opening 14 and the frame portion 15 at the periphery of the opening 14. The lid 20 closes the opening 14 at the closed position of the lid 20 such that the lid 20 is flush with the vehicle body surface 2. The surface of the lid 20 may be curved so as to match the vehicle body surface 2. The lid 20 is, for example, an injection-molded article molded from a resin.

The lid 20 is opened/closed between the closed position and the opened position. The closed position is a position at which the lid 20 closes the opening 14. In addition, the opened position is a predetermined position at which the lid 20 opens the opening 14. The lid 20 is supported so as to be movable in position relative to the lid box 10. The lid 20 is opened/closed by the power generated by the actuator 30 without a manual operation of an operator such as a vehicle user.

The actuator 30 is a power generation part that generates power for opening/closing the lid 20. The actuator 30 is an electric motor or the like that rotates and generates power when electric power is supplied thereto. The actuator 30 is capable of both opening and closing the lid 20, and is rotatable in both a forward direction and a reverse direction. The actuator 30 may be capable of only either opening or closing the lid 20, and may be rotatable in only either a forward direction or a reverse direction.

The forward direction may refer to a direction in which the lid 20 is opened from the closed position to the opened position, and the reverse direction may refer to a direction in which the lid 20 is closed from the opened position to the closed position. In addition, in the following, the forward direction and the reverse direction are applied not only to the operation of the actuator 30, but also to the operation of each component of the link mechanism 60 described in detail later.

The actuator 30 is capable of being rotationally driven in a direction selected from the forward direction and the reverse direction. The actuator 30 is rotationally driven in the forward direction in accordance with an opening command from a controller when a predetermined switch opening operation (e.g., an operation of pressing a switch 19 shown in FIG. 1, FIG. 2, and FIG. 3) is performed by the operator at the closed position of the lid 20. In this case, the lid 20 is opened. In addition, the actuator 30 is rotationally driven in the reverse direction in accordance with a closing command from the controller when a predetermined switch closing operation (e.g., an operation of pressing the switch 19) is performed by the operator at the opened position of the lid 20. In this case, the lid 20 is closed.

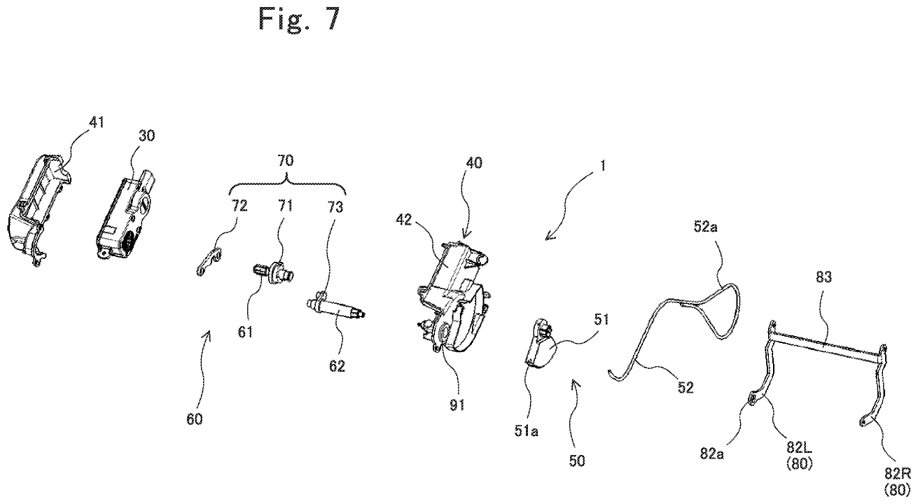

The actuator box 40 is a box-like box body in which the actuator 30 is housed. The actuator box 40 supports the actuator 30 such that the actuator 30 is operable (rotatable). The actuator box 40 includes an upper box 41 and a lower box 42 which form a space in which the actuator 30 and some components of the link mechanism 60 are housed (see FIG. 7). The actuator 30 and the some components of the link mechanism 60 are housed in the above space by fastening the upper box 41 and the lower box 42. The actuator box 40 is placed outside the internal space 13 of the lid box 10 and mounted and fixed to the lid box 10 in a state where various components are housed in the above space.

The external force operation mechanism 50 is a mechanism that operates to convert an external force caused by a manual operation into power for opening the lid 20. As shown in FIG. 7, the external force operation mechanism 50 includes a rotation member 51 and a wire 52.

The rotation member 51 is a rotatable member. The rotation member 51 only has to be shaped so as to allow the rotation member 51 to rotate by a force acting in the circumferential direction, and is formed in a sector shape. The rotation member 51 may be formed in a disk shape or a cylindrical shape, for example. In addition, the rotation member 51 may be integrally incorporated into the link mechanism 60.

The rotation member 51 is placed outside the space surrounded by the upper box 41 and the lower box 42. The rotation member 51 is placed so as to be exposed to the outside of the lower box 42 (specifically, the outside on the side opposite to the upper box 41 side in the lower box 42). The rotation member 51 is placed on a side, which is the same as the side on which the lid box 10 is placed, with respect to the actuator 30, and is placed on the inner side, that is, closer to the center, of the lid box 10 and the lid 20 with respect to the actuator 30. The rotation member 51 is rotatably supported on the lower box 42, and is rotatable coaxially with an output shaft of the actuator 30. A rotation shaft of the rotation member 51 coincides with a rotation shaft of the actuator 30, and is coaxial with the rotation shaft of the actuator 30.

The rotation member 51 has a groove 51a formed at an outer edge thereof. The groove 51a is open radially outward. The wire 52 is an external force application portion that applies an external force to the rotation member 51. One end portion of the wire 52 is fixed on the outer periphery of the rotation member 51. The wire 52 is configured such that a part thereof is fitted along the groove 51a of the rotation member 51. An operation portion 52a which is capable of being pulled and operated by the operator is provided at another end portion of the wire 52. When the operation portion 52a is pulled and operated in an emergency, the wire 52 is pulled in a tangential direction with a fixed point on the outer periphery of the rotation member 51 as a fulcrum, thereby applying an external force caused by the manual operation to the rotation member 51. When the external force is applied from the wire 52 to the rotation member 51, the rotation member 51 rotates in the forward direction so as to convert the external force into power for opening the lid 20.

The link mechanism 60 is a mechanism that transmits the power generated by the actuator 30 and the power generated by the operation of the external force operation mechanism 50, to the lid 20. The link mechanism 60 includes an actuator shaft 61, a lid shaft 62, a shaft-to-shaft transmission mechanism 70, and a lid arm mechanism 80.

The actuator shaft 61 is a shaft member that is rotatable by the power generated by the actuator 30 and is also rotatable by the power generated by the operation of the external force operation mechanism 50. The actuator shaft 61 extends coaxially with the output shaft of the actuator 30 and also extends coaxially with the rotation shaft of the rotation member 51. The actuator shaft 61 is fitted to the output shaft of the actuator 30 at one axial end (specifically, at the left end) thereof. In addition, the actuator shaft 61 is fitted to the rotation shaft of the rotation member 51 at another axial end (specifically, at the right end) thereof.

When the actuator 30 operates and the output shaft thereof rotates, power is transmitted from the actuator 30 to the one axial end side of the actuator shaft 61. In this case, the actuator shaft 61 rotates about an axis Z1 integrally with the output shaft of the actuator 30 as the output shaft of the actuator 30 rotates. The actuator shaft 61 may be the output shaft of the actuator 30 itself. In addition, the actuator shaft 61 may not necessarily be coaxial with the output shaft of the actuator 30, and may be connected to the output shaft via a speed reducer or a link.

The actuator shaft 61 is placed on one side in an axial direction with respect to the actuator 30, and specifically, the actuator shaft 61 is placed on the inner side, that is, closer to the center, of the lid box 10 and the lid 20 with respect to the actuator 30. The actuator shaft 61 projects in the axial direction from the inner side to the outer side of the lower box 42 (i.e., the side opposite to the upper box 41 side). That is, the actuator shaft 61 is placed such that the one axial end thereof is connected to the output shaft of the actuator 30 and the other axial end thereof is located outside the lower box 42. The actuator shaft 61 is rotatably supported on the lower box 42. The above rotation member 51 is rotatable about the axis Z1 coaxially with the output shaft of the actuator 30 and further the actuator shaft 61.

When no power is generated by pulling and operating the wire 52 of the external force operation mechanism 50, the rotation member 51 does not rotate, and power transmission to the actuator shaft 61 due to the rotation of the rotation member 51 is not performed, so that the actuator shaft 61 does not rotate. On the other hand, when power is generated by pulling and operating the wire 52, the rotation member 51 rotates, and power transmission to the actuator shaft 61 due to the rotation of the rotation member 51 is performed. At this time, the actuator shaft 61 rotates in the forward direction about the axis Z1 integrally with the rotation member 51.

The lid shaft 62 is a shaft member that rotates and transmits power to the lid 20 as the actuator shaft 61 rotates. The lid shaft 62 is connected to the actuator shaft 61 via the shaft-to-shaft transmission mechanism 70. The axis Z1 along which the actuator shaft 61 extends and an axis Z2 along which the lid shaft 62 extends extend parallel to each other. The actuator shaft 61 and the lid shaft 62 are placed so as to be spaced apart from each other in a radial direction thereof. The axis Z2 of the lid shaft 62 extends parallel to the axis Z1 of the actuator shaft 61 at a position different from that of the axis Z1.

The lid shaft 62 is rotatably supported on the actuator box 40 (specifically, the lower box 42). One axial end portion of the lid shaft 62 is housed in a space within the actuator box 40. The lid shaft 62 is fitted at the one axial end portion (specifically, a left end portion) thereof to a third link 73 described later. The lid shaft 62 projects outward from the actuator box 40 and extends toward the lid box 10 side. Another axial end portion of the lid shaft 62 is inserted into the internal space 13 of the lid box 10. That is, the lid shaft 62 extends in a shaft shape between the actuator box 40 side and the lid box 10 side. The lid shaft 62 is fitted at the other axial end portion (specifically, a right end portion) thereof to a second arm 82 described later.

The shaft-to-shaft transmission mechanism 70 is a mechanism that performs power transmission between the actuator shaft 61 and the lid shaft 62. As shown in FIG. 6 and FIG. 7, the shaft-to-shaft transmission mechanism 70 includes a first link 71, a second link 72, and the third link 73. The first link 71, the second link 72, and the third link 73 are each formed in an arm shape. The first link 71, the second link 72, and the third link 73 are connected in series between the actuator shaft 61 and the lid shaft 62 in this order. The first link 71, the second link 72, and the third link 73 are housed in the space surrounded by the upper box 41 and the lower box 42 of the actuator box 40.

The first link 71 is configured such that one end portion thereof is connected to the actuator shaft 61 (specifically, on its axis) and rotatable about the axis Z1 integrally with the actuator shaft 61, and another end portion thereof is relatively rotatably supported on one end portion of the second link 72. The second link 72 is configured such that the one end portion thereof is relatively rotatably supported on the other end portion of the first link 71, and another end portion thereof is relatively rotatably supported on one end portion of the third link 73. The third link 73 is configured such that the one end portion thereof is relatively rotatably supported on the other end portion of the second link 72, and another end portion thereof is connected to the lid shaft 62 (specifically, its one axial end portion) and rotatable about the axis Z2 integrally with the lid shaft 62.

The first link 71 rotates about the axis Z1 integrally with the actuator shaft 61 as the actuator shaft 61 rotates. The second link 72 moves (changes a posture thereof) in conjunction with the rotation of the first link 71 about the axis Z1. In addition, the third link 73 rotates about the axis Z2 integrally with the lid shaft 62 in conjunction with the movement of the second link 72. The lid shaft 62 rotates about the axis Z2 in conjunction with the rotation of the third link 73. Therefore, the lid shaft 62 rotates by the power generated by the actuator 30.

The first link 71 may be integrally formed on the outer circumferential surface of the actuator shaft 61, or may be mounted and fixed so as to be integrated with the outer circumferential surface of the actuator shaft 61. In addition, the third link 73 may be integrally formed on the outer circumferential surface of the lid shaft 62, or may be mounted and fixed so as to be integrated with the outer circumferential surface of the lid shaft 62.

The lid arm mechanism 80 is a mechanism that transmits power between the lid shaft 62 and the lid 20 to open/close the lid 20. As shown in FIG. 2, FIG. 7, etc., the lid arm mechanism 80 includes a first arm 81 and the second arm 82. The first arm 81 and the second arm 82 are each formed in an arm shape. The first arm 81 and the second arm 82 are interposed between the lid box 10 side and the lid 20 side.

The first arm 81 and the second arm 82 rotate in synchronization with each other by the rotation of the lid shaft 62, thereby opening/closing the lid 20 while maintaining a state where the lid 20 is parallel to the vehicle body surface 2 and the opening 14. The first arm 81 and the second arm 82 are placed in parallel with each other between the lid box 10 side and the lid 20 side. The first arm 81 and the second arm 82 are placed so as to penetrate the bottom wall portion 11 of the lid box 10 between the near side and the far side.

As the first arm 81, a pair of arms are provided so as to be spaced apart from each other in the right-left direction X when seen from the front side of the lid 20. As the second arm 82, a pair of arms are provided so as to be spaced apart from each other in the right-left direction X when seen from the front side of the lid 20. Hereinafter, the first arm 81 on the right side and the first arm 81 on the left side are respectively referred to as first arm 81R and first arm 81L as appropriate, and the second arm 82 on the right side and the second arm 82 on the left side are respectively referred to as second arm 82R and second arm 82L as appropriate. The second arm 82R and the second arm 82L are coupled to each other via a coupling bar 83 (see FIG. 7). The first arm 81R and the first arm 81L may be coupled to each other via a coupling bar or the like, but may not necessarily be coupled to each other.

The lid shaft 62 is configured such that the one axial end portion thereof is connected to the other end portion of the third link 73 of the shaft-to-shaft transmission mechanism 70, and the other axial end portion thereof is connected to the lid 20 (specifically, the second arm 82 (e.g., the second arm 82L on the left side)). The one axial end portion of the lid shaft 62 is integrated with the third link 73. The other axial end portion of the lid shaft 62 is inserted into a fitting hole 82a provided in the second arm 82 and is integrated with the second arm 82. The second arm 82 rotates about the axis Z2 as the lid shaft 62 rotates.

The first arms 81 and the second arms 82 are each an arm member extending with one end portion in the arm longitudinal direction thereof being rotatably supported on the lid box 10 and another end portion in the arm longitudinal direction thereof being rotatably supported on the lid 20. Each first arm 81 is located above each second arm 82. The rotation fulcrum of the first arm 81 and the rotation fulcrum of the second arm 82 are located at positions different from each other. The direction in which the shaft extends at the rotation fulcrum of each of the first arm 81 and the second arm 82 is the above right-left direction X.

The pair of right and left first arms 81R and 81L rotate in synchronization with each other on the same axis at one end portions in the arm longitudinal direction thereof, and rotate in synchronization with each other on the same axis at other end portions in the arm longitudinal direction thereof. The pair of right and left second arms 82R and 82L rotate in synchronization with each other on the same axis at one end portions in the arm longitudinal direction thereof, and rotate in synchronization with each other on the same axis at other end portions in the arm longitudinal direction thereof. The first arms 81 and the second arms 82 cooperatively rotate in synchronization with each other about the respective rotation fulcrums thereof, thereby opening/closing the lid 20 while maintaining a state where the lid 20 is parallel to the vehicle body surface 2 and the opening 14.

As shown in FIG. 2 to FIG. 4, the bottom wall portion 11 of the lid box 10 has a second through hole 11b and a third through hole 11c. The second through hole 11b is a hole through which the first arm 81R and the second arm 82R on the right side penetrate. The third through hole 11c is a hole through which the first arm 81L and the second arm 82L on the left side penetrate. The second through hole 11b is provided on the right side of the first through hole 11a. The third through hole 11c is provided on the left side of the first through hole 11a. The second through hole 11b and the third through hole 11c are each formed in a long hole shape extending in the up-down direction Z so as to permit the first arm 81 and the second arm 82 to rotate during opening/closing of the lid 20. The second through hole 11b and the third through hole 11c may be connected to the first through hole 11a and formed as one hole.

In the present embodiment, the lid shaft 62 of the link mechanism 60 is mounted to the actuator box 40 side before assembly between the actuator box 40 and the lid box 10 is performed. For example, after the lid shaft 62 is fitted at the one axial end portion thereof to the third link 73 of the shaft-to-shaft transmission mechanism 70, the respective links 71, 72, and 73 including the third link 73 are housed in the actuator box 40, whereby the one axial end portion of the lid shaft 62 is mounted to the actuator box 40 side.

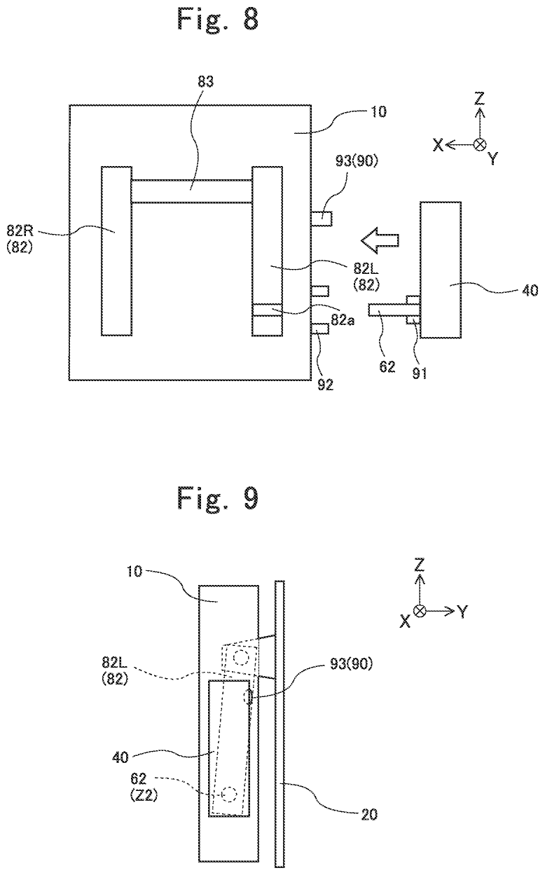

The actuator box 40 and the lid box 10 have a guide portion 90. The guide portion 90 is a portion that performs guiding between both boxes 40 and 10 when assembly between the actuator box 40 and the lid box 10 is performed. The assembly between both boxes 40 and 10 is performed by inserting and fitting the other axial end portion of the lid shaft 62 into the fitting hole 82a of the second arm 82. The guide portion 90 has a first insertion guide portion 91 (see FIG. 7 and FIG. 8), a second insertion guide portion 92 (see FIG. 8), and a rotation guide portion 93 (see FIG. 8 to FIG. 12).

The first insertion guide portion 91 and the second insertion guide portion 92 are each a portion that guides the actuator box 40 and the lid box 10 which move relative to each other when the other axial end portion of the lid shaft 62 is inserted into the fitting hole 82a of the second arm 82. The first insertion guide portion 91 is provided to the actuator box 40. The first insertion guide portion 91 is placed at a location surrounding the lid shaft 62 in the actuator box 40. In addition, the second insertion guide portion 92 is provided to the lid box 10. The second insertion guide portion 92 is placed at a location surrounding the fitting hole 82a of the second arm 82 in the lid box 10.

The first insertion guide portion 91 may be the lid shaft 62 itself, or may include the lid shaft 62. The second insertion guide portion 92 may be the fitting hole 82a of the second arm 82 itself, or may include the fitting hole 82a.

The first insertion guide portion 91 and the second insertion guide portion 92 each extend in a columnar shape or a cylindrical shape in the direction in which the actuator box 40 and the lid box 10 move relative to each other when being assembled (specifically, the right-left direction X). The first insertion guide portion 91 has a projection portion. The second insertion guide portion 92 has a recess. The first insertion guide portion 91 and the second insertion guide portion 92 engage each other by inserting the projection portion of the first insertion guide portion 91 into the recess of the second insertion guide portion 92, thereby assisting the actuator box 40 and the lid box 10 in moving relative to each other in the right-left direction X. The actuator box 40 is guided to the lid box 10 by inserting the projection portion of the first insertion guide portion 91 into the recess of the second insertion guide portion 92 while the outer circumferential surface of the projection portion of the first insertion guide portion 91 is sliding on the inner circumferential surface of the recess of the second insertion guide portion 92.

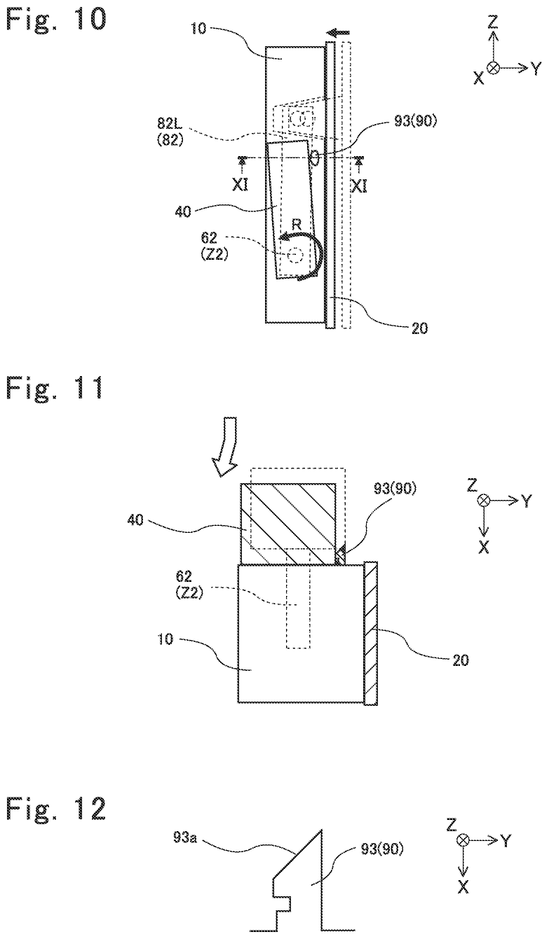

The rotation guide portion 93 is a portion that guides the actuator box 40 and the lid box 10 which rotate relative to each other in a process in which the assembly between the actuator box 40 and the lid box 10 proceeds by inserting the lid shaft 62 into the fitting hole 82a of the second arm 82. The rotation guide portion 93 rotates the actuator box 40 about the axis of the lid shaft 62 (i.e., the axis Z2) toward a lid closing side R (see FIG. 10) with respect to the lid box 10 in the process in which the assembly proceeds.

Specifically, in the process in which the assembly between the actuator box 40 and the lid box 10 proceeds, after the other axial end portion of the lid shaft 62 mounted at the one axial end portion thereof to the actuator box 40 side is inserted and fitted into the fitting hole 82a of the second arm 82 on the lid box 10 side, the rotation guide portion 93 rotates the entire actuator box 40 including the lid shaft 62 about the axis Z2 toward the lid closing side R with respect to the lid box 10.

The rotation of the actuator box 40 with respect to the lid box 10 by the rotation guide portion 93 only has to be started after the fitting of the other axial end portion of the lid shaft 62 into the fitting hole 82a of the second arm 82 is started, and specifically, this rotation is preferably started after this fitting is completed. The “lid closing side R” refers to the reverse direction in which the lid 20 is closed from the opened position side toward the closed position side, out of the forward direction and the reverse direction in which the lid shaft 62 rotates about the axis Z2.

The rotation guide portion 93 is provided to the lid box 10. The rotation guide portion 93 is formed on a surface, of the lid box 10, which faces in the right-left direction X in which the actuator box 40 and the lid box 10 move relative to each other when being assembled and which opposes the actuator box 40, such that the rotation guide portion 93 projects toward the actuator box 40 side. The rotation guide portion 93 is provided at a position displaced relative to the axis Z2 of the lid shaft 62. The rotation guide portion 93 may be integrally formed on the lid box 10, or may be retrofitted to the lid box 10 by welding, bolting, or the like.

As shown in FIG. 12, the rotation guide portion 93 has an inclined surface 93a. The inclined surface 93a is a surface inclined in the front-back direction Y with respect to the right-left direction X in which the actuator box 40 and the lid box 10 move relative to each other when being assembled. The inclined surface 93a is inclined in a direction (leftward in FIG. 12) in which the actuator box 40 rotates about the axis Z2 toward the lid closing side R with respect to the lid box 10 in the process in which the above assembly proceeds. In the process in which the above assembly proceeds, the inclined surface 93a comes into contact with an outer wall of the actuator box 40 and applies a force for rotating the actuator box 40 toward the lid closing side R, to the actuator box 40. The inclined surface 93a preferably extends in the up-down direction Z.

A rotation angle at which the rotation guide portion 93 rotates the actuator box 40 about the axis Z2 toward the lid closing side R with respect to the lid box 10 only has to be set in consideration of the range of a tolerance that may occur in the link mechanism 60, and is preferably set such that a state where the lid 20 closes the opening 14 is ensured for a maximum value of the tolerance.

The actuator box 40 and the lid box 10 have a mounting fixing portion 95. The mounting fixing portion 95 is a portion that mounts the actuator box 40 to the lid box 10 to fix both boxes 40 and 10 to each other. The method by which the mounting fixing portion 95 fixes both boxes 40 and 10 to each other may be any method, and may be, for example, screwing, claw-fitting, gluing, welding, and the like. Hereafter, the fixing method is assumed to be only screwing.

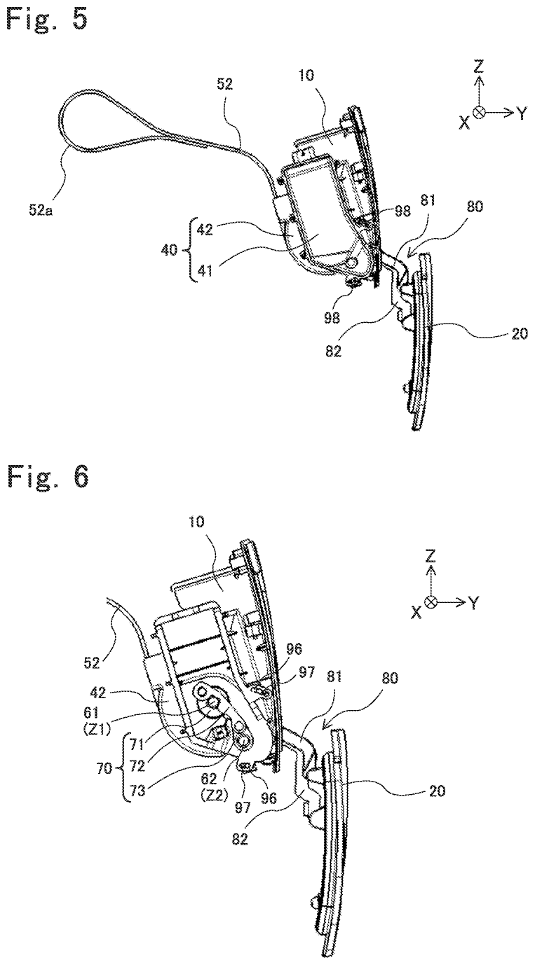

The mounting fixing portion 95 has a mounting projection portion 96 (see FIG. 6), a mounting hole portion 97 (see FIG. 6), and a nut portion 98 (see FIG. 5). The mounting projection portion 96 and the mounting hole portion 97 are formed in shapes corresponding to each other at positions corresponding to each other. Specifically, the mounting projection portion 96 is formed in a projection shape, and the mounting hole portion 97 is a hole opened with a size that allows the mounting projection portion 96 to be inserted thereinto.

An external thread is formed on a distal end portion of the mounting projection portion 96. In addition, an internal thread is formed in the nut portion 98. The nut portion 98 is fastened to the mounting projection portion 96 inserted into the mounting hole portion 97, by tightening the external thread of the mounting projection portion 96 to the internal thread. Accordingly, the actuator box 40 and the lid box 10 are fixed to each other in a predetermined relative positional relationship including a placement angle relationship about the axis Z2.

The mounting projection portion 96 is provided at two locations on the lid box 10. The mounting projection portions 96 at the two locations are placed around the axis Z2. The mounting hole portion 97 is provided at two locations on the actuator box 40. The mounting hole portions 97 at the two locations are placed around the axis Z2. Each mounting hole portion 97 is formed in a long hole shape extending around the axis Z2. The mounting hole portion 97 allows the mounting projection portion 96 to move within the mounting hole portion 97 by a predetermined angle about the axis Z2 before both boxes 10 and 40 are fixed. That is, the actuator box 40 and the lid box 10 are rotatable relative to each other about the axis Z2 within the range where the mounting projection portion 96 is movable in the mounting hole portion 97 in a state where the mounting projection portion 96 is inserted into the mounting hole portion 97. Therefore, the placement angle between the actuator box 40 and the lid box 10 around the axis Z2 is adjustable.

Next, an assembly procedure for the lid opening/closing device 1 will be described.

First, all components for forming the lid opening/closing device 1 are prepared. Then, the actuator box 40 side is assembled, and the lid box 10 side is also assembled.

The assembly of the actuator box 40 side is performed, for example, by: fitting the lid shaft 62 to the third link 73 of the shaft-to-shaft transmission mechanism 70 at one axial end portion thereof; mounting the actuator shaft 61, the lid shaft 62, and the respective links 71, 72, and 73 to the lower box 42; mounting the actuator 30 to the lower box 42; fastening the upper box 41 to the lower box 42; and mounting the rotation member 51 and the wire 52 to the outside of the actuator box 40. In addition, the assembly of the lid box 10 side is performed, for example, by mounting the first arms 81 and the second arms 82 to the lid box 10 at one end portions thereof and mounting the first arms 81 and the second arms 82 to the lid 20 at other end portions thereof.

After the above assembly between the respective boxes 40 and 10 is performed, both boxes 40 and 10 are assembled together. This assembly is performed by first setting the opened/closed position of the lid 20 such that the opening 14 is closed in the lid box 10; setting both boxes 10 and 40 such that a predetermined placement angle relationship is established between the lid box 10 and the actuator box 40; and inserting the other axial end portion of the lid shaft 62 on the actuator box 40 side into the fitting hole 82a of the second arm 82 on the lid box 10 side.

The above “predetermined placement angle relationship” refers to an angle, about the axis Z2, at which the lid box 10 and the actuator box 40 are allowed to be positioned by the mounting fixing portion 95 and mounted on each other.

In the process of assembly between both boxes 40 and 10, first, the projection portion of the first insertion guide portion 91 of the guide portion 90 is inserted into the recess of the second insertion guide portion 92 to engage both insertion guide portions 91 and 92 with each other. When this engagement is made, the lid shaft 62 on the actuator box 40 side is inserted and fitted into the fitting hole 82a of the second arm 82 on the lid box 10 side. When this fitting is completed, components including the second arms 82, the first arms 81 connected to the second arms 82, and the lid 20, among the components on the lid box 10 side, are mounted to the actuator box 40 side. In addition, when the above engagement of both insertion guide portions 91 and 92 is started, then (preferably after the engagement is completed), the actuator box 40 is brought into contact with the inclined surface 93a of the rotation guide portion 93 on the lid box 10 side.

In a state where the actuator box 40 is in contact with the inclined surface 93a of the rotation guide portion 93, when the above assembly (i.e., movement of both boxes 40 and 10 in the approaching direction in the right-left direction X) proceeds, the actuator box 40 slides on the inclined surface 93a and a force for rotating the actuator box 40 about the axis Z2 toward the lid closing side R is applied to the actuator box 40. In this case, the actuator box 40 rotates about the axis Z2 toward the lid closing side R with respect to the lid box 10. The rotation of the actuator box 40 about the axis Z2 with respect to the lid box 10 is performed along with a closing motion of the lid 20 and the lid arm mechanism 80 including the second arms 82 connected to the lid shaft 62.

When end surfaces, in the right-left direction X, of both boxes 40 and 10 come into contact with each other to stop the movement of both boxes 40 and 10 in the approaching direction, or the actuator box 40 and the inclined surface 93a of the rotation guide portion 93 are brought into non-contact with each other, the rotation of the actuator box 40 about the axis Z2 with respect to the lid box 10 is stopped. Thereafter, both boxes 40 and 10 are fixed to each other in a predetermined relative positional relationship at the mounting fixing portion 95.

As described above, as for the lid opening/closing device 1, in the process in which the assembly between the actuator box 40, in which the lid shaft 62 is fitted to the third link 73 of the shaft-to-shaft transmission mechanism 70, and the lid box 10, on which the lid arm mechanism 80 and the lid 20 are mounted, proceeds, first, the lid shaft 62 on the actuator box 40 side is fitted to the second arms 82 on the lid box 10 side, and the outer wall of the actuator box 40 is then brought into contact with the inclined surface 93a of the rotation guide portion 93 on the lid box 10 side, thereby rotating the actuator box 40 about the axis Z2 toward the lid closing side R with respect to the lid box 10.

After the lid shaft 62 is fitted to the second arms 82, when the actuator box 40 rotates about the axis Z2 toward the lid closing side R with respect to the lid box 10, the second arms 82, on the lid box 10 side, which are fitted to the lid shaft 62 rotate in the reverse direction, and the lid 20 is closed toward the closed position.

Therefore, even if there is a clearance in the link mechanism 60 or the like between the actuator 30 and the lid 20 due to a tolerance or the like, by rotating the actuator 30 side about the axis Z2 toward the lid closing side R with respect to the lid box 10 when the actuator box 40 and the lid box 10 are assembled together, the lid 20 is moved to the closed position, or the lid 20 is brought into contact with the opening periphery of the lid box 10 to increase a force for closing the opening 14. Therefore, rattling of the lid 20 due to the clearance in the link mechanism 60 is suppressed.

If the actuator box 40 and the lid box 10 are erroneously assembled together, specifically, if the placement angle relationship about the axis Z2 between the actuator box 40 and the lid box 10 in the process of assembly between both boxes 40 and 10 is different from the desired one, even when this assembly is performed, a situation in which the actuator box 40 comes into contact with the inclined surface 93a of the rotation guide portion 93 on the lid box 10 side is less likely to occur, so that a situation in which the actuator box 40 rotates about the axis Z2 toward the lid closing side R with respect to the lid box 10 is less likely to occur. In this case, the state of the lid 20 with respect to the lid box 10 is no longer limited to the closed position.

Therefore, when the actuator box 40 and the lid box 10 are erroneously assembled together, the occurrence of the erroneous assembly is easily recognized by an operator for the assembly, or the like. That is, when the assembly between the actuator box 40 and the lid box 10 is completed without any error, the state of the lid 20 with respect to the lid box 10 is limited to the closed position, so that the assemblability of the lid opening/closing device 1 is improved.

Next, the operation of the lid opening/closing device 1 will be described.

In the lid opening/closing device 1, when no operation is performed on the switch 19, the actuator 30 is not rotationally driven, and the wire 52 is not pulled and operated, no power is generated by the actuator 30, and no power is generated by the operation of the external force operation mechanism 50, so that the lid 20 is locked at the closed position by frictional force or the like.

When an opening operation is performed on the switch 19 at the closed position of the lid 20, the actuator 30 rotates in the forward direction so as to generate power for opening the lid 20. When this rotation in the forward direction occurs, the actuator shaft 61 rotates in the forward direction about the axis Z1 integrally with the actuator 30 as the actuator 30 rotates. When the actuator shaft 61 rotates in the forward direction, the power is transmitted to the lid shaft 62 via the shaft-to-shaft transmission mechanism 70. When this transmission is performed, the lid shaft 62 rotates in the forward direction about the axis Z2 in conjunction with the rotation of the third link 73 of the shaft-to-shaft transmission mechanism 70.

When the lid shaft 62 rotates in the forward direction as described above, each second arm 82 rotates in the forward direction by the rotation of the lid shaft 62, and each first arm 81 rotates in the forward direction in synchronization with the rotation of the second arm 82. When each first arm 81 and each second arm 82 rotate in the forward direction, the lid 20 is opened from the closed position toward the opened position while maintaining the state of being parallel to the vehicle body surface 2 and the opening 14. The opening motion of the lid 20 is continued until reaching the opened position at which the lid 20 is fully opened.

When a closing operation is performed on the switch 19 at the opened position of the lid 20, the actuator 30 rotates in the reverse direction so as to generate power for closing the lid 20. When this rotation in the reverse direction occurs, the actuator shaft 61 rotates in the reverse direction about the axis Z1 integrally with the actuator 30 as the actuator 30 rotates. When the actuator shaft 61 rotates in the reverse direction, the power is transmitted to the lid shaft 62 via the shaft-to-shaft transmission mechanism 70. When this transmission is performed, the lid shaft 62 rotates in the reverse direction about the axis Z2 in conjunction with the rotation of the third link 73 of the shaft-to-shaft transmission mechanism 70.

When the lid shaft 62 rotates in the reverse direction as described above, each second arm 82 rotates in the reverse direction by the rotation of the lid shaft 62, and each first arm 81 rotates in the reverse direction in synchronization with the rotation of the second arm 82. When each first arm 81 and each second arm 82 rotate in the reverse direction, the lid 20 is closed from the opened position toward the closed position while maintaining the state of being parallel to the vehicle body surface 2 and the opening 14. The closing motion of the lid 20 is continued until reaching the closed position.

Therefore, in the lid opening/closing device 1, when the switch 19 is operated by the operator, the actuator 30 is caused to generate power, and the power is transmitted to the actuator shaft 61 of the link mechanism 60, the shaft-to-shaft transmission mechanism 70, the lid shaft 62, each second arm 82, each first arm 81, and the lid 20 in this order to open/close the lid 20 between the closed position and the opened position.

When the wire 52 is pulled and operated by an external force of the operator at the fully closed position of the lid 20, the external force is transmitted to the actuator shaft 61 via the rotation member 51, and the actuator shaft 61 rotates in the forward direction. In this case, since the power generated by the pulling operation on the wire 52 is transmitted to the lid shaft 62 via the shaft-to-shaft transmission mechanism 70, the lid shaft 62 rotates in the forward direction, each second arm 82 and each first arm 81 rotate in the forward direction, and the lid 20 is opened from the closed position toward the opened position while maintaining a state where the lid 20 is parallel to the vehicle body surface 2 and the opening 14. The opening motion of the lid 20 by this power is performed until reaching a position that is before the opened position at which the lid 20 is fully opened.

Therefore, in the lid opening/closing device 1, when the wire 52 is pulled and operated by the operator at the closed position of the lid 20, the external force caused by the manual operation of the operator is converted into power for opening the lid 20, whereby this power is transmitted to the actuator shaft 61 of the link mechanism 60, the shaft-to-shaft transmission mechanism 70, the lid shaft 62, each second arm 82, each first arm 81, and the lid 20 in this order to open the lid 20 from the closed position.

In the above embodiment, the lid shaft 62 corresponds to “shaft member” described in the claims.

Meanwhile, in the above embodiment, the rotation guide portion 93 is provided to the lid box 10. However, the present invention is not limited thereto, and the rotation guide portion 93 may be provided to the actuator box 40 as well as to the lid box 10 or instead of the lid box 10. In the case where the rotation guide portion 93 is provided to each of the lid box 10 and the actuator box 40, both rotation guide portions 93 only have to cooperate to rotate the actuator box 40 about the axis Z2 of the lid shaft 62 toward the lid closing side R with respect to the lid box 10.

In the above embodiment, the lid shaft 62 is mounted to the third link 73 on the actuator box 40 side before the actuator box 40 and the lid box 10 are assembled together, and when the actuator box 40 and the lid box 10 are then assembled together, the lid shaft 62 is inserted and mounted in the fitting hole 82a of the second arm 82 on the lid box 10 side. However, the present invention is not limited thereto, and conversely, the lid shaft 62 may be mounted to each second arm 82 on the lid box 10 side before the actuator box 40 and the lid box 10 are assembled together, and when the actuator box 40 and the lid box 10 are then assembled together, the lid shaft 62 may be inserted and mounted in a fitting hole of the third link 73 on the actuator box 40 side.

In the above embodiment, the mounting fixing portion 95 for fixing the actuator box 40 to the lid box 10 is provided, and the mounting fixing portion 95 is a screw type having the mounting projection portion 96 provided to the lid box 10, the mounting hole portion 97 provided to the actuator box 40, and the nut portion 98. However, the present invention is not limited thereto, and the mounting fixing portion 95 may be a claw-fitting type.

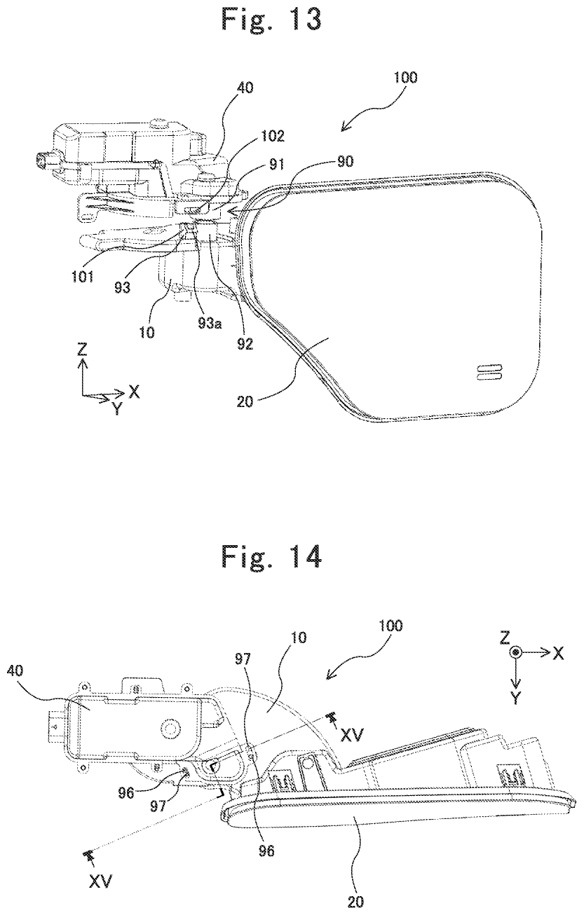

For example, as shown in FIG. 13 to FIG. 15, in a lid opening/closing device 100, the mounting fixing portion 95 may have a first engagement portion 101 and a second engagement portion 102 in addition to the mounting projection portion 96, the mounting hole portion 97, etc. The first engagement portion 101 and the second engagement portion 102 are portions that fix the actuator box 40 and the lid box 10 to each other by engaging each other. In the lid opening/closing device 100, as shown in FIG. 13 to FIG. 15, unlike the lid opening/closing device 1 described above, the lid 20 is opened/closed in the right-left direction X, not in the up-down direction Z, and the placement relationship between the lid box 10 and the actuator box 40 is different by 90° from that in the lid opening/closing device 1.

The first engagement portion 101 is an engagement projection portion formed in a claw shape. The first engagement portion 101 is provided to the lid box 10. The first engagement portion 101 is formed integrally with the rotation guide portion 93 described above. The first engagement portion 101 is formed in a claw shape using the inclined surface 93a of the rotation guide portion 93. The second engagement portion 102 is an engagement hole portion formed in a hole shape with which the first engagement portion 101 is fitted and engaged. The second engagement portion 102 is provided to the actuator box 40. When the first engagement portion 101 and the second engagement portion 102 engage each other, even if the first insertion guide portion 91 and the second insertion guide portion 92 attempt to move in directions in which the first insertion guide portion 91 and the second insertion guide portion 92 are separated from each other, a claw distal end portion of the first engagement portion 101 comes into contact with a hole peripheral portion of the second engagement portion 102 to prevent such movement.

According to this modification, after the assembly between the actuator box 40 and the lid box 10 is completed, both boxes 40 and 10 are restricted from moving in the directions in which both boxes 40 and 10 are separated from each other. In addition, since the rotation guide portion 93 (specifically, the inclined surface 93a) for rotating the actuator box 40 about the axis Z2 with respect to the lid box 10 is configured as a part of the claw-shaped projection portion forming the first engagement portion 101 for fixing both boxes 40 and 10, the structure of the lid opening/closing device 1 is simplified.

In this modification, the first engagement portion 101, which is an engagement projection portion, is provided to the lid box 10 to which the rotation guide portion 93 is provided, and the second engagement portion 102, which is an engagement hole portion, is provided to the actuator box 40. However, in the case where the rotation guide portion 93 is provided to the actuator box 40, the first engagement portion 101, which is an engagement projection portion, may also be provided to the actuator box 40, and the second engagement portion 102, which is an engagement hole portion, may be provided to the lid box 10.

The second engagement portion 102 is an engagement hole portion with which the first engagement portion 101 is fitted and engaged. However, the second engagement portion 102 may be formed in any shape as long as the shape is a shape that allows the first engagement portion 101 to be engaged with the second engagement portion 102, and the second engagement portion 102 may be an engagement projection portion formed in a claw shape as in the first engagement portion 101.

Furthermore, in the above embodiment, the actuator 30 and a part of the link mechanism 60 (specifically, including at least the shaft-to-shaft transmission mechanism 70) are housed in the actuator box 40, and the other part of the link mechanism 60 (specifically, including at least the lid arm mechanism 80) is housed in the lid box 10. The lid shaft 62, which is to extend between the third link 73 of the shaft-to-shaft transmission mechanism 70 and each second arm 82 of the lid arm mechanism 80, is mounted to the actuator box 40 side at one axial end side thereof before both boxes 40 and 10 are assembled together, and is assembled to the lid box 10 side at the other axial end side thereof by the assembly between both boxes 40 and 10.

However, the present invention is not limited thereto, and only the actuator 30 may be housed in the actuator box 40, and all the components of the link mechanism 60 may be housed in the lid box 10. In this configuration, for example, the actuator shaft 61 extending between the actuator box 40 side and the lid box 10 side may be mounted to the actuator box 40 side at one axial end side thereof before both boxes 40 and 10 are assembled together, and may be assembled to the lid box 10 side at the other axial end side thereof by the assembly between both boxes 40 and 10. In this modification, the actuator shaft 61 corresponds to “shaft member” described in the claims.

At least a part of the link mechanism 60 may be placed outside the actuator box 40 and the lid box 10. In this configuration, for example, the shaft member existing between the components on the actuator box 40 side and the components on the lid box 10 side may be mounted to the actuator box 40 side at one axial end side thereof before both boxes 40 and 10 are assembled together, and may be assembled to the lid box 10 side at the other axial end side thereof by the assembly between both boxes 40 and 10.

The present invention is not limited to the above-described embodiment and modifications, and various changes may be made without departing from the gist of the present invention. In addition, the present specification discloses not only the technical concept indicated by the citation relationship between the claims as originally filed, but also the technical concept obtained by combining the matters recited in each claim as appropriate.

This application claims priority on Japanese Patent Application No. 2023-017994 filed in Japan on Feb. 8, 2023, the entire contents of which are incorporated herein by reference.

1. A lid opening/closing device comprising:
a lid box having an internal space and an opening through which the internal space is exposed to outside;
a lid configured to be opened/closed between a closed position at which the opening is closed and an opened position at which the opening is opened;
an actuator configured to generate power for opening/closing the lid;
an actuator box in which the actuator is housed and which is placed outside the internal space of the lid box; and
a link mechanism interposed between the actuator and the lid and configured to transmit the power generated by the actuator to the lid, wherein
the link mechanism includes a shaft member extending in a shaft shape between the actuator box side and the lid box side and configured to rotate by the power,
the shaft member is mounted to one side out of the actuator box and the lid box at one axial end portion thereof before assembly between the actuator box and the lid box is performed,
the other side out of the actuator box and the lid box has a fitting hole into which another axial end portion of the shaft member is inserted,
the actuator box and the lid box have a guide portion configured to guide the actuator box and the lid box when the assembly is performed by inserting the other axial end portion of the shaft member into the fitting hole, and
the guide portion has a rotation guide portion provided to at least one of the actuator box and the lid box and configured to rotate the actuator box about an axis of the shaft member toward a lid closing side with respect to the lid box in a process in which the assembly proceeds.

2. The lid opening/closing device according to claim 1, wherein the rotation guide portion has an inclined surface configured to come into contact with the actuator box or the lid box and apply a force for rotating the actuator box toward the lid closing side with respect to the lid box, to the actuator box or the lid box in the process in which the assembly proceeds.

3. The lid opening/closing device according to claim 1, wherein the actuator box and the lid box have a mounting fixing portion configured to fix the actuator box and the lid box to each other in a state where rotation of the actuator box toward the lid closing side is completed.

4. The lid opening/closing device according to claim 3, wherein
the rotation guide portion has an inclined surface configured to come into contact with the actuator box or the lid box and apply a force for rotating the actuator box toward the lid closing side with respect to the lid box, to the actuator box or the lid box in the process in which the assembly proceeds, and
the mounting fixing portion has an engagement portion formed in at least one of the actuator box and the lid box in a claw shape using the inclined surface.
